(19) United States
(12) Patent Application Publication
(10) Pub. No.: US 2009/0070700 A1
(43) Pub. Date: Mar. 12, 2009

(54) RANKING CONTENT BASED ON SOCIAL NETWORK CONNECTION STRENGTHS

(75) Inventor: Cynthia Johanson, San Francisco, CA (US)

Correspondence Address: BEYER LAW GROUP LLP/YAHOO, PO BOX 1687, CUPERTINO, CA, 95015-1687, US

(73) Assignee: YAHOO! INC., Sunnyvale, CA (US)

(21) Appl. No.: 11/851,629

(22) Filed: Sep. 7, 2007

(51) Int. Cl. G06F 3/048

(52) U.S. Cl. 715/776

(57) ABSTRACT

In one embodiment, a method for presenting content to a user via a web page is provided which includes assigning a value to a connection between the user and an entity (such as a person, group, or organization) in their social network, whether explicitly representing a one-to-one relationship or by implication of a person to a group. Then a web page is delivered to the user, wherein the web page displays content based at least partially on the value of the connection between the user and the entity.

### BACKGROUND OF THE INVENTION

1. Field of the Invention

The present invention relates to social network connections. More particularly, the present invention relates to ranking content based on social network connection strengths.

2. Description of the Related Art

A person's social network can be important for improving a person's personal life, such as in finding people with similar interests, making new friends, and finding a mate. Social networks are also important for a person's professional life, with increased value during particular points in one's life. Recent college graduates, for example, typically find it difficult to transition from their lives as college students into lives as working professionals. The primary difficulty in this transition is finding a job, as college graduates typically have little or no work experience by which to make a career decision or qualify for a position. In order to overcome this hurdle, many recent college graduates rely on their social network connections for career advice and help finding a job.

### SUMMARY OF THE INVENTION

In one embodiment, a method for presenting content to a user via a web page is provided which includes assigning a value to a connection between the user and an entity (such as a person, group, or organization) in their social network, whether explicitly representing a one-to-one relationship or by implication of a person to a group. Then a web page is delivered to the user, wherein the web page displays content based at least partially on the value of the connection between the user and the entity.

### BRIEF DESCRIPTION OF THE DRAWINGS

FIG. 1 is a screen capture illustrating a web page presenting content based on the strength of connections in a user's social network.

FIG. 2 is a flow diagram illustrating a method for presenting content to a user via a web page.

FIG. 3 is a block diagram illustrating an apparatus for presenting content to a user via a web page.

FIG. 4 is an exemplary network diagram illustrating some of the platforms that may be employed with various embodiments of the invention.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

In accordance with the present invention, the components, process steps, and/or data structures may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

In accordance with an embodiment of the present invention, connections between people are tracked and the strength of the connections are assigned a value, either directly or relatively. Content may then be delivered to a user based at least partially upon the strength of a cumulative connection between the user and one entity (such as a person, group, or organization) in the user's social network.

A social network may be established to represent sets of nodes with varying degrees of separation. These nodes may be arranged with directed and quantified edges that establish connections between the nodes. The nodes can represent persons, locations, other entities, information and the like. The edges on the directed graph may be weighted according to a quantification of the underlying connection.

Connections may be quantified using various different mechanisms. In one embodiment, a user is prompted to rank the strength of a connection (e.g., on a scale of 1 to 10, with 1 being the strongest). In another embodiment, the user may be asked to describe the type of relationship (or this information is inferred from other sources) and then a predesignated quantification is assigned based on the type of the relationship. For example, the user may indicate that the relationship is familial, friend, colleague, acquaintance, etc. A familial relationship may be designated a stronger quantification level than an acquaintance.

In another embodiment, behavior is monitored to determine the strength of the relationship. For example, a user's emailing behavior may help determine the number of times the user has communicated with a possible network node.

Once the connections in a user's social network have been quantified, content may be delivered at least partially based upon the strength of a relationship. Many different types of content are envisioned. A job opportunity from a connection may be sent to the user. The quantification of the strength of the connection may be used to filter which job opportunities are presented to the user and in what order. For example, a job opportunity available through a close family member may be given higher priority than a job opportunity from an old high school acquaintance. The same is true of other content, such as news items clipped by the connection and bulletin-board postings. The content delivered to a user's screen can be arranged on the page based on the strength of the relationships as well. For example, perhaps content from close connections will appear at the top of the screen in large font while content from more distant connections will appear at the bottom of the screen in small font.

When serving a particular web page, a node of a particular entity or entities may be accessed. For example, when a user access a company web site, the company's node may be accessed as well as the user's node. Corresponding connections to and from the relevant nodes may be analyzed to determine which connections represent the strongest connections. This information may then be used in determining which information to display to the user (e.g., favoring information from strong connections over general information or information from weaker connections).

In one embodiment, the connection rankings are periodically re-evaluated with respect to each user to make sure the most relevant content, based on connection strength, is the most prominently displayed. For example, 3 tight connections may be more relevant to a user than 1 distant connection, and the ranking requires re-evaluating all the people associated with an entity to figure out which one is the closest.

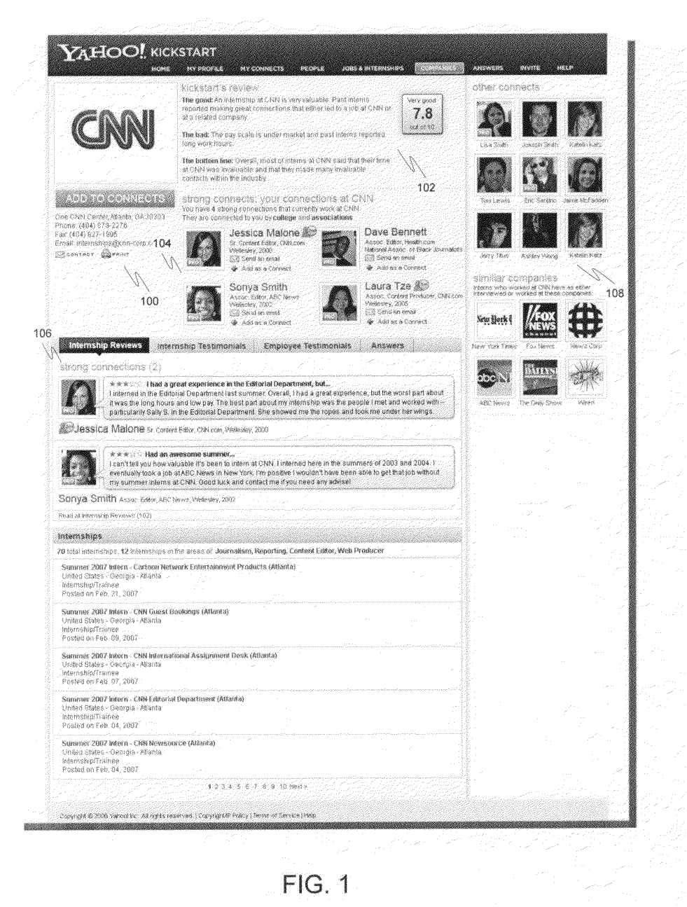

FIG. 1 is a screen capture illustrating a web page presenting content based on the strength of connections in a user's social network. Here, the user has elected to find out more information about a company (CNN). The web page presents various information about the company such as a basic description 100 and comments 102. Additionally, the user's strong connections that work at the company 104 are presented. Comments from these strong connections 106 are also presented, in the order of those written by the connections that are closest to the user.

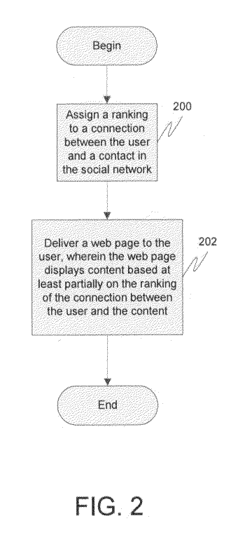

FIG. 2 is a flow diagram illustrating a method for presenting content to a user via a web page. At 200, a ranking is assigned to a connection between the user and an entity in a social network. The entity may be a contact such as a person, an organization, group, or other entity. This may include prompting the user to provide a value for the connection based on relationship strength between the user and the entity. Alternatively, this may include prompting the user to provide a relationship category for the entity and automatically assigning a ranking to the connection based upon the relationship type. Alternatively, this may include determining relationship strength between the user and the entity by monitoring user behavior and automatically assigning a ranking to the connection based upon the relationship strength. The value may be direct (i.e., absolute) or relative. At 202, a web page is delivered to the user, wherein the web page displays content based at least partially on the ranking of the connection between the user and the contact. The location and/or size of the content on the web page may be altered based at least partially on the ranking. Alternatively, certain content may not be displayed in favor of other content relating to an entity associated with a user having a connection with a higher ranking.

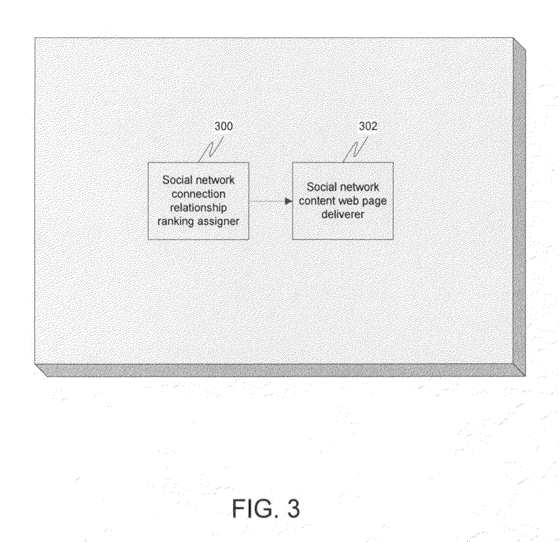

FIG. 3 is a block diagram illustrating an apparatus for presenting content to a user via a web page. A social network connection relationship ranking assigner 300 may perform step 200 of FIG. 2. A social network content web page deliverer 302 coupled to the social network connection relationship ranking assigner 300 may perform step 202 of FIG. 2.

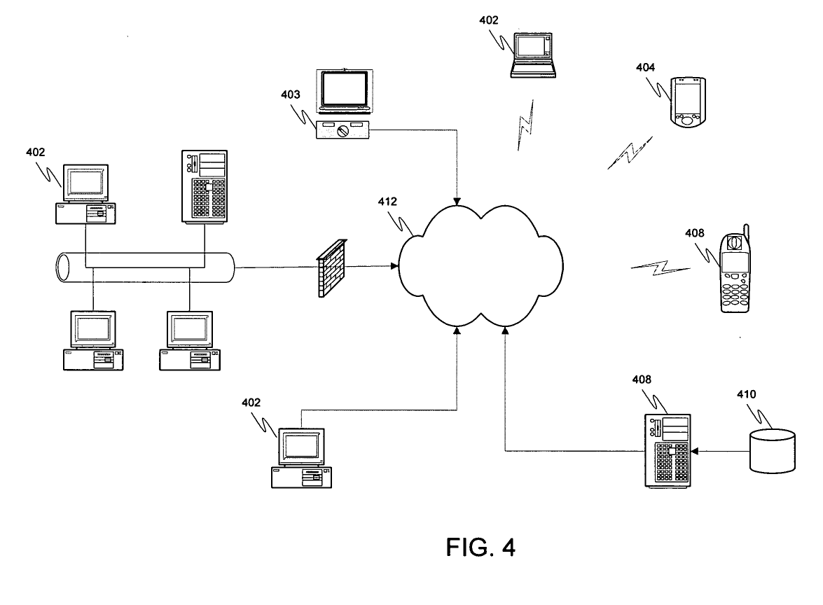

It should also be noted that embodiments of the present invention may be implemented on any computing platform and in any network topology in which presentation of search results is a useful functionality. For example and as illustrated in FIG. 4, implementations are contemplated in which the invention is implemented in a network containing personal computers 402, media computing platforms 403 (e.g., cable and satellite set top boxes with navigation and recording capabilities (e.g., Tivo)), handheld computing devices (e.g., PDAs) 404, cell phones 406, or any other type of portable communication platform. Users of these devices may navigate the network, and this information may be collected by server 408. Server 408 (or any of a variety of computing platforms) may include a memory, a processor, and a communications component and may then utilize the various techniques described above. The processor of the server 408 may be configured to run, for example, all of the processes described in FIG. 2. Server 408 may be coupled to a database 410, which stores information relating connection rankings. Applications may be resident on such devices, e.g., as part of a browser or other application, or be served up from a remote site, e.g., in a Web page (also represented by server 408 and database 410). The invention may also be practiced in a wide variety of network environments (represented by network 412), e.g., TCP/IP-based networks, telecommunications networks, wireless networks, etc. The invention may also be tangibly embodied in one or more program storage devices as a series of instructions readable by a computer (i.e., in a computer readable medium).

It should also be noted that the term “web page” shall be interpreted broadly to refer to any information or graphical user interface or that is displayed on an electronic device, as least some of which is received via transmission over a network. This may include, for example, pages displayed on web browsers on computers but may also include pages displayed on cellular phones, personal data assistants, media devices or other electronic devices.

While the invention has been particularly shown and described with reference to specific embodiments thereof, it will be understood by those skilled in the art that changes in the form and details of the disclosed embodiments may be made without departing from the spirit or scope of the invention. In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A method for presenting content to a user via a web page, the method comprising:
assigning a ranking to a connection between the user and an entity in a social network; and
delivering a web page to the user, wherein the web page displays content based at least partially on the ranking of the connection between the user and the contact.

2. The method of claim 1, wherein the assigning a ranking includes:
prompting the user to provide a value the connection based on relationship strength between the user and the entity.

3. The method of claim 1, wherein the assigning a ranking includes:
prompting the user to provide a relationship category for the entity; and
automatically assigning a value to the connection based upon the relationship category.

4. The method of claim 1, wherein the assigning a ranking includes:
determining relationship strength between the user and the entity by monitoring user behavior; and
automatically assigning a ranking to the connection based upon the relationship strength.

5. The method of claim 1, wherein the position relative at which the content is displayed on the web page relative to other content is altered based at least partially on the ranking.

6. The method of claim 1, wherein the size, color, or other distinguishing marks in which the content is displayed on the web page is altered based at least partially on the ranking.

7. The method of claim 1, wherein content relating to an entity of the user having a connection with a first ranking is not displayed in favor of content related to an entity of a user having a connection with a second ranking, wherein the second ranking is a stronger ranking than the first ranking.

8. The method of claim 1, wherein the ranking is a number between 1 and 10, wherein 1 represents the strongest ranking and 10 represents the weakest ranking.

9. An apparatus comprising:
a social network connection relationship ranking assigner; and
a social network content web page deliverer coupled to the social network connection relationship ranking assigner.

10. An apparatus for presenting content to a user via a web page, the apparatus comprising:
means for assigning a ranking to a connection between the user and an entity in a social network; and
means for delivering a web page to the user, wherein the web page displays content based at least partially on the ranking of the connection between the user and the entity.

11. The apparatus of claim 10, wherein the means for assigning a ranking includes:
means for prompting the user to provide a value the connection based on relationship strength between the user and the entity.

12. The apparatus of claim 10, wherein the means for assigning a ranking includes:
means for prompting the user to provide a relationship category for the entity; and
means for automatically assigning a value to the connection based upon the relationship category.

13. The apparatus of claim 10, wherein the means for assigning a ranking includes:
means for determining relationship strength between the user and the entity by monitoring user behavior; and
means for automatically assigning a ranking to the connection based upon the relationship strength.

14. The apparatus of claim 10, wherein the location the content is displayed on the web page is altered based at least partially on the ranking.

15. The apparatus of claim 10, wherein the position relative at which the content is displayed on the web page relative to other content is altered based at least partially on the ranking.

16. The apparatus of claim 10, wherein the size, color, or other distinguishing marks in which the content is displayed on the web page is altered based at least partially on the ranking.

17. The apparatus of claim 10, wherein the ranking is a number between 1 and 10, wherein 1 represents the strongest ranking and 10 represents the weakest ranking.

18. A program storage device readable by a machine tangibly embodying a program of instructions executable by the machine to perform a method for presenting content to a user via a web page, the method comprising:
assigning a ranking to a connection between the user and an entity in a social network; and
delivering a web page to the user, wherein the web page displays content based at least partially on the ranking of the connection between the user and the entity.
